(19) United States
(12) Patent Application Publication
(10) Pub. No.: US 2007/0095946 A1
(43) Pub. Date: May 3, 2007

(54) Advanced Velocity Nozzle Fluid Technology

(75) Inventor: John Ross Ryan, Tucson, AZ (US)

Correspondence Address: JOHN ROSS RYAN, 1901 N. WILMOT, # 2024, TUCSON, AZ, 85712, US

(73) Assignee: John Ross Ryan, Tucson, AZ (US)

(21) Appl. No.: 10/906,974

(22) Filed: Sep. 26, 2005

(51) Int. Cl. B05B 7/06

(52) U.S. Cl. 239/430

(57) ABSTRACT

A high pressure advanced velocity nozzle comprised of concatenated modules, each of which modules contains an interior bore for carrying a primary fluid, each module being coupled to the adjacent succeeding and/or preceding module so as to create an area for a boundary layer to be formed with a secondary fluid for reducing surface tension of the primary fluid flowing within the bore and for increasing the velocity of the primary fluid.

### BACKGROUND OF THE INVENTION

1. Field of the Invention

The present invention relates in general to high pressure fluid nozzle discharge apparatus and, in particular, to an improved high pressure fluid nozzle discharge apparatus that allows a primary fluid stream to be surrounded by a secondary fluid stream that is projected into the nozzle through spaced, annular, angled grooves in the female portion of a matching male-female module junction to cause the primary stream to have a greater stream density and a greater fluid projection distance or a greater vapor content and increased vapor projection distance. The present invention also relates to being able to project a fluid that can also contain solid material or projectiles introduced into the primary fluid flow. The present invention also relates to an invention that can utilize it's body and a conical attachment that can deflect a stream while allowing for the penetration of a barrier or obstacle and then fold back to allow the projection of the above mentioned linear stream into a cavity or space and deliver a desired fluid in a desired state to carry out a particular task.

2. Description of the Prior Art

In U.S. Pat. Nos. 4,809,911 and 4,915,300, there is disclosed a high pressure mixing and spray apparatus comprised of fixedly connected modules wherein a secondary fluid such as air, can be introduced in one or more modules in such a manner as to interact with the primary fluid such as water to bring about a desired result.

The technology has the ability to mix and deliver primary fluids or solids in fluid form. As a result the High Pressure Mixing and spray apparatus gives a result with high velocity and less flair.

The components of one embodiment of the device are the pressure back pressure module, the expulsion chamber and the accelerator module. In this embodiment, at the rear of the device in the pressure back pressure module, the secondary fluid surrounds the primary fluid and imparts turbulence and cavitations to accomplish mixing of the primary of the secondary fluids and to provide some linear momentum to the primary fluid. In some cases, too much pressure can result in a loss of performance. The device has a provision for relieving excess pressure to a secondary fluid input in a forward module known as the accelerator module. Located immediately forward of the pressure back pressure module is the expulsion chamber module that can include a unidirectional orifice that is centrally located within the stream and points toward the outlet end located in the next module, the accelerator module. Within the expulsion chamber module (as well as within the first module), a secondary fluid can be introduced into the primary fluid flow.

In the accelerator module, located forward of the pressure back pressure module and the expulsion chamber module, there are a series of angled holes or slits in rows that progressively decline in angle which serve to accelerate the primary and secondary fluids. Again, in the accelerator module, a secondary fluid is used to impart velocity to the primary fluid.

A desired primary fluid wave form is intended to be initially formed with the use of the first row of holes or slits and the following rows of holes or slits tend to help to sharpen the wave form. This total apparatus is intended primarily for relatively low primary fluid pressures in the realm of twenty to forty pounds per square inch. The apparatus will function at higher pressures but with diminishing results.

The technology set forth in the above patents describes a nozzle that is dependent on at least two modules being present to accomplish the task of delivering a primary and at least one secondary fluid to the outlet, and the possibility of additional secondary fluids. In the accelerator module, as set forth above, a first row of holes or slits have a 17 degree angle and are radially oriented around the circumference of the inner member for the introduction of the secondary fluid, i.e. air. Following rows of holes or slits decline in angle.

Because the secondary fluid is introduced directly into the fluid stream at an angle and a series of declining angles, the incoming secondary fluid is immediately sheared off by the passage of the primary fluid. This shearing of the secondary fluid by the primary fluid stream causes a loss of performance in most cases. The ideal angles that are sought can occur only when the primary fluid is in a narrow range of pressures that are lower than the pressure of the secondary fluid. Also, the accelerator module must over come the turbulence induced in the expulsion chamber by the secondary fluid.

Because of the number of the holes or slits that are drilled, the relationship of primary fluid flow to secondary fluid flow is fixed and while the pressure can be varied, the over all volume that is allowed in terms of flow is also fixed. Thus, the total volume of the secondary fluid through the holes in relationship to the primary fluid volume is of a fixed relationship. The modularity does not suitably accommodate anything other than a given fixed relationship of primary fluid flow to the secondary fluid flow. Thus, the mixing and spray technology is realistically limited to a preferred lower pressure range, primarily due to fluid cavitations and the limitations of the technology as set forth above.

It would be advantageous to have a high pressure spraying and mixing nozzle that could accommodate higher pressures of both the primary and secondary fluids and would allow for greater control over the amount of vapor to meet the needs of various sizes and applications. It would also be advantageous to have a nozzle that had superior performance in both higher and lower pressure ranges.

The present invention improves the operation of the type of nozzle disclosed in U.S. Pat. Nos. 4,809,911 and 4,915,300. The novel nozzle of the present invention can deliver primary and secondary fluids or flowable solids and it can use more than one secondary fluid as does the prior art. It does however deliver them in a different manner. It can be used to deliver chemicals and liquids to fight fires and to deliver hollow round projectiles at great distances and to provide thrust that can power a water vehicle such as a boat. It also is more efficient in the use of energy.

### SUMMARY OF THE INVENTION

The novel high pressure fluid nozzle has several improvements over the prior art.

First, the nozzle includes at least one mating male and female module through which the secondary fluid is admitted to the primary fluid. The female module has an open core or center for the flow of primary fluid. It also has one end in the shape of a truncated cone with the interior surface thereof having at least one longitudinally extending groove through which the secondary fluid is enabled to travel to the primary fluid. Preferably, a plurality of spaced longitudinally extending grooves are formed on the inside surface of the conical shaped end of the female module to admit the secondary fluid. The male module has at least an end portion whose outside surface is shaped for fluid tight mating relationship with the female module so as to prevent any fluid flow between the male and female modules except through the longitudinally extending spaced grooves.

Second, the male module end portion extends slightly into the open core or center of the female module. The inside diameter of the open core or center of the male module is slightly smaller than the open core or center diameter of the female module. The difference in diameter is extremely small (approximately 0.002 inch) and is not noticeable with the naked eye. However, this diameter change is very important as it allows the incoming secondary fluid to expand into the volume around the primary fluid created by the diameter change. Thus, there is no shearing of the secondary fluid as was the case in the prior art. Also, the secondary fluid forms a circumferential boundary layer on the outside of the primary fluid stream. This boundary layer provides for a stream that is primarily liquid and increases the velocity of the primary fluid so that it travels a great distance when it leaves the nozzle. If a greater amount of vapor is required, the pressure of the secondary fluid is increased and the secondary fluid penetrates deeper into the primary fluid and agitates the primary fluid while increasing the velocity of the primary fluid. This allows a stream of primarily vapor to travel at great distances when it leaves the nozzle. If a greater amount of vapor is required, the pressure and/or volume of the secondary fluid is increased and the secondary fluid penetrates deeper into the primary fluid and agitates the primary fluid while increasing the velocity of the primary fluid. This allows a stream of primarily vapor to travel at great distances when it leaves the nozzle.

Also when using three modules in concatenated relationship, the second module also has an input end that is in the shape of a truncated cone and, on the inside surface of the truncated cone, at least one, but preferably several, longitudinally extending grooves are formed to allow passage of the secondary fluid (or a tertiary fluid) to the primary fluid when the male end of the third module is inserted therein.

By rotating the position of the longitudinally extending grooves of the second module with respect to the position of the longitudinally extending grooves in the first module, the secondary fluid imparts a rotation to the primary fluid as it exits the nozzle.

Such a rotating fluid assists in getting fire fighting fluid, for example only, into oddly positioned portions of a device, such as getting behind the fan blades of an aircraft engine, while attempting to extinguish a fire. By rotating the position of the longitudinally extending grooves of a third module with respect to the position of the longitudinally extending grooves of the second module, it is possible to form a variety of complex interactive wave forms that can result in a specific desired end effect on the stream type in angular rotation or linear output and in the degree of vaporization and mixing that is occurring. Also, any particular combination or plurality of male/female module combinations may be used to form a particular nozzle for a particular fire or a particular reason. In one embodiment, the novel invention can have a solid as the secondary fluid in the form of a projectile that is spherical. Such projectile may be hollow and made of frangible material, well known in the art, such that a fire retardant agent, a chemical agent, or a biological agent could be contained in the hollow projectile. The use of a fire retardant agent is obvious. The use of a chemical agent could be advantageous for cleaning contaminated areas or delivering tear gas at great distances. The use of a biological agent could be used for delivering bacteria to treat an oil spill. Those skilled in the art will realize the various advantages of using a projectile containing a treatment material for various reasons. The use of a projectile may be accomplished by the attachment of an additional module to any other module or group of modules having an entrance orifice of a size that will enable a flowable solid or substantially solid secondary fluid to be admitted to the primary fluid. In one embodiment, a port for the admission of the solids extends at an angle into the addition module until it is received by the primary fluid. Flowable solids such as steel ball bearings may be accelerated out of a proper size nozzle.

Finally, the nozzle is so effective in ejecting water that it could be used as an energy source for a liquid propelled watercraft such as a boat. Water can be sucked into the main ejector nozzle from the body of water as is well known in the art and its velocity can be increased, and controlled, with the addition of a pressurized secondary fluid.

The present invention has performance advantages over the prior art in that it has the ability to control to a greater degree the interaction of the secondary fluid with the primary fluid. In practical terms, this interaction produces a stream type that can be more suited to fit a number of different applications. It has the ability to modify the interaction of the fluid components to change the stream of primary fluid from one task that requires predominantly water to one that requires predominantly vapor.

Also the novel invention uses a unique aperture for delivering the secondary fluid to the primary fluid. At least one aperture, preferably in the form of a longitudinally extending or elongated groove, is formed in the female conical surface of a first module that receives a conical male portion of a second module in fluid tight relationship. The only way that the secondary fluid can get to the primary fluid is through the elongated groove or aperture in a direction that takes into account the bending force exerted by the primary fluid stream on the secondary fluid stream. This bending, due to the greater mass of the primary fluid, flattens the angle of attack of the secondary fluid and is referred to as the ideal net deflection angle for enabling the secondary fluid to impart increased velocity and mixing to the primary fluid. This bending is taken into account in the present invention. The effect is further enhanced by the properties of the primary fluid flow bore diameter change and the positive effect it has on each secondary fluid inlet as the secondary fluid enters the primary fluid flow. The diameter of the primary fluid carrying orifice through the female module is slightly larger than the diameter of the primary fluid carrying orifice of the preceding male module. This slight change in diameter provides advantages for the novel invention. First, it enables the conical male portion of the second module to extend partially into the slightly larger bore. Thus, it creates an area in which a vapor boundary layer is formed and in which the secondary fluid (air) is received and surrounds the primary fluid and reduces surface tension of the primary fluid with the wall of the fluid carrying orifice of the female module and any succeeding modules. This allows an increased velocity of the primary fluid through the fluid carrying orifice. Second, the slight change in diameter also allows the secondary fluid to exit the groove without upstream interference from the primary fluid. Thus there is no shearing of the secondary fluid as it enters the primary fluid as it does in the prior art as explained earlier.

With a low secondary fluid pressure, the secondary fluid slightly constricts the primary fluid as it, the secondary fluid, fills the vapor boundary space circumferentially about the primary fluid stream and thus the output stream from the nozzle is clean and straight and has a greater percentage or amount of fluid droplets than vapor.

As the pressure/volume of the secondary fluid is increased, the force of the secondary fluid entering the primary fluid tends to impart both velocity and mixing to the primary fluid and causes the output stream to have a greater percentage or amount of vapor formed with smaller droplets of fluid.

The ideal net deflection angle at which the secondary fluid enters the primary flow is slightly greater than 17° with diameter flows over ½ inches and less when smaller sizes are used. It varied with relation to the diameter of the primary fluid orifice. The fact that the secondary fluid is prevented from being sheared by the primary fluid as it enters the primary fluid makes it possible for both the primary and the secondary fluids to be increased in pressure and thus the secondary fluid enters the primary stream with a greater velocity and at an ideal angle. This action was not available with the prior art. Thus, this nozzle has the ability to satisfy a variety of practical uses.

The at least one aperture or groove may be a single groove or multiple spaced grooves formed in the conical surface of either the male or female mating surface. In the preferred embodiment, the at least one groove is formed in the conical female mating surface of a given module.

The size of the groove or aperture will of course vary with the type of secondary fluid being used. For instance, a flowable solid material being used as the secondary fluid may requires a different size groove or aperture. Also, such flowable, substantially solid, material or spherical hollow frangible objects containing a particular agent may be injected into the primary fluid stream through a hose or tube upstream of the nozzle in a well known manner to enable the nozzle to be hand held without interference from the solid material secondary fluid entry lines. The size of the flowable solid material will also be limited by the bore size of the primary fluid discharge nozzle.

When multiple apertures or grooves are used, they may be symmetrically or asymmetrically spaced about the conical surface of a given module. The apertures or grooves may be odd in number to be asymmetrical and even in number to be symmetrical.

The apertures may be grooves that are angled downwardly in the horizontal direction on the conical surface. Such arrangement could be used to cause the primary stream to be torqued and rotate in the direction of the groove angle. Obviously the stream could be rotated either clockwise or counterclockwise.

Such operation enables the fluid stream to penetrate into areas or cavity like spaces that are hidden behind another object created by such as a burning aircraft engine.

Such fluid stream rotation could also be achieved by staggering subsequent rows of grooves or apertures in modules. One row of grooves in one module may be rotated a few degrees circumferentially with respect to another row of grooves in an adjacent module. The secondary fluid, as it passes through successively rotated modules (or stages) is rotating and imparts a corresponding rotation to the primary fluid.

In addition, the use of multiple mating male/female modules, with an adjacent module having the at least one aperture or groove, enables multiple secondary fluids to be added without changing the desired configuration of the primary fluid stream. The diameter of the bore that carries the primary fluid can be decreased in an adjacent upstream second module to allow the device to operate with the same degree of performance at a lower volume flow per minute as a practical way to regulate the flow rate of the primary fluid volume.

Thus, it is an object of the present invention to provide an improved high velocity fluid nozzle that can advantageously cause the output fluid stream to have either a greater percentage of vapor than fluid or a greater percentage of fluid than vapor to suit a particular task.

It is also an object of the present invention to enable a spherical projectile, either solid or hollow (and, if hollow, containing a particular treatment material) to be used as the secondary fluid.

It is yet another object of the present invention to provide a fluid nozzle that projects a high velocity fluid stream that can be used to power and propel water craft such as boats, jet skis, and torpedoes.

It is yet another object of the present invention to provide a fluid nozzle that consists of internally stackable components that allow for changes in model type within the body.

It is yet another object of the present invention to provide a external shape that will allow for the external attachment of a outer housing that is partly conical in shape at the front with a tip that is hinged can be used for penetration of walls or barriers. The hinged tip folds back allowing the device to provide positive pressure and suppression in a cavity such as an aircraft or a building.

It is yet a still another object of this present invention to be able to attach a conventional nozzle to the end for use in conventional applications that do not require the high performance aspects of this novel nozzle.

It is yet another object of this invention to be able to attach a conventional pneumatic drill or prying device and utilize the compressed air as a power source for a means of penetration and access should a conical wedge or spherical projectiles not be suited to the task.

It is still another object of the present invention to provide a fluid nozzle for mixing a primary fluid with a secondary fluid with the use of a pair of mating male/female modules, each pair having a primary fluid carrying bore or orifice and at least one groove or aperture for receiving and conducting a secondary fluid to the primary fluid such that the entry of the secondary fluid into the common primary fluid carrying bore is not subject to shearing by the primary fluid and enters at a direction that is substantially parallel to the primary fluid flow

It is still another object of the present invention to control the manner in which the secondary fluid merges with the primary fluid to vary the primary stream characteristics.

It is yet another object of the invention to provide concatenated modules or groups of concatenated modules that allow for the addition of several different secondary fluids to be added to the primary fluid.

It is also an object of the present invention to provide mating male/female modules that have primary fluid carrying orifices that increase in diameter in the downstream direction sufficient to form a boundary layer space for the secondary fluid to allow it to form around the circumference of the primary fluid flow.

It is also an object of the present invention to be made in various sizes to accommodate a variety of volumetric flow rates.

Thus, the present invention relates to a high velocity fluid nozzle comprising at least one set of male/female modules having a central bore for carrying a primary fluid, the female module having one end in the shape of a truncated cone, the cone having an inside surface, at least one groove extending longitudinally on the inside surface of the truncated cone for allowing a secondary fluid to be added to the primary fluid, the male module having at least a portion of one end that engages the inside surface of the truncated cone in a fluid tight relationship except for the at least one groove that admits the secondary fluid.

The invention also relates to a high velocity fluid nozzle comprising at least one set of male/female modules having mating fluid tight surfaces, each module having a central bore for carrying a primary fluid, at least one groove extending longitudinally in one of the mating surfaces of at least a portion of at least one of the modules, the diameter of the central bore of the female module being slightly larger than the central bore of the male module to allow a secondary fluid passing through the at least one groove to expand into the larger diameter and form a boundary layer that encircles and encases the primary fluid.

### BRIEF DESCRIPTION OF THE DRAWINGS

These and other more detailed objects of the present invention will be disclosed in the following Detailed Description of the Drawings in which like numbers represent like objects and in which;

FIG. 1(a)-(i) are cross-sectional representations of the various modules and components that can be used with the present invention; FIG. 2 is a cross-sectional representation of a two-module male/female combination forming a first embodiment of the novel high pressure nozzle of the present invention;

FIG. 3 is a cross-sectional representation of a three-module male/female combination forming a second embodiment of the novel high pressure nozzle of the present invention;

FIG. 4 is a cross-sectional representation of a four-module male/female combination forming a third embodiment of the novel high pressure nozzle of the present invention;

FIG. 5 is a cross-sectional representation of two spaced groups of a three-module male/female combination forming a fourth embodiment of the novel high pressure nozzle of the present invention; and

FIG. 6 is a cross-sectional representation of a module that can be used to insert spherical solid or hollow flowable material into the primary fluid stream.

FIG. 7 is a cross-sectional representation of the novel high pressure nozzle of the present invention with an attachment for forced penetration through a barrier. It also shows a provision for the mounting of a camera and a light within the body. It also shows a variation on the supply of air that streamlines the body.

### DETAILED DESCRIPTION OF THE DRAWINGS

It should be understood that in the following detailed description of the drawings, whenever the term “secondary fluid” appears, it is intended to include the support equipment for providing the source of the secondary fluid such as compressed air tanks, a compressor and water supply pump or source, a flowable solid material ejector, and the like, all well known in the art.

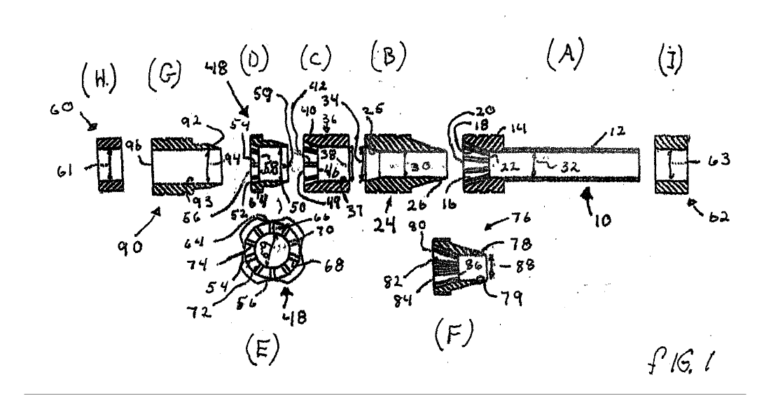

FIG. 1 is a cross-sectional view of various insert modules that can be used to form the various embodiments of the present invention. In FIG. 1(a), an output module 10 is shown. It has an output nozzle section 12 and an input section 14. The input section 14 includes an interior truncated cone portion 16 having at least one groove 18 formed therein (a plurality of grooves are shown). The at least one groove 18 extends from the outer end 20 of the truncated cone to the truncated end 22 that lies on the plane of the inside surface of the output nozzle section 12 that has an inside diameter 32. The inside diameter 32 always carries the primary fluid. The output module 10 is always the fluid output end of the high velocity nozzle.

FIG. 1(b) is a cross-sectional view of a spacer module 24. It has a conical shaped male end that has an outer portion 26 with a conical shape that matches the truncated cone shape 16 of the output module 10 shown in FIG. 1(a) in a fluid tight sealing relationship such that a secondary fluid can flow only through the at least one groove (e.g. 18 in output nozzle 10) to reach the primary fluid. The inside diameter 30 of the primary fluid carrying bore in spacer module 10 is slightly smaller than the inside diameter of the mating module (e.g. diameter 32 of the output module 10). This is an important inventive feature of the novel fluid nozzle and will be discussed in more detail in relation to the various embodiments of the present invention. Spacer module 24 also has a fluid input end with an inside diameter 34 that is greater than the inside diameter 30. However, it has no grooves. It is simply a spacer that matches an input diameter from a module to an output diameter that matches another module input.

FIG. 1(c) is a cross-sectional view of another spacer module 36. It has an output end with an inside diameter 38 that matches the inside diameter 34 of the input end of module 24. It also has an input end 44 with an interior conical shaped truncated cone 40 that, again, has at least one longitudinally extending groove 42 that extends from input end 44 to the end 46 of the truncated cone 40. The diameter 38 of the interior bore 37 matches the diameter of a mating bore (e.g. 34 of spacer module 24).

FIG. 1(d) is a cross-sectional view of another type of spacer module 48. Module 48 has a male end 50 and a female end 56 that has a conical shaped interior 52 that, again, has at least one longitudinally extending groove 54 that extends inwardly and downwardly from input end 56 to the end 58 of the truncated cone 52. The male end 50 is also conically shaped with an interior bore diameter 59 that matches the bore diameter of a mating module (e.g. 38 of FIG. 1(c)). A front view of spacer module 38 is shown in FIG. 1(e). Note that at least one recess 64 is formed in the outer periphery of the input end 56. This is an important feature of the present invention that will be described in detail later herein. Suffice it to say at present that it allows a secondary fluid to pass therethrough to enter the grooves 54 of the module 48 where it can flow to the primary fluid. Note that an asymmetrical array of grooves (i.e. 3 grooves) 54, 66, and 68 may be used if desired. Also shown in phantom lines are additional grooves, some of which are shown as 70, 72, and 74. A symmetrical arrangement of 10 grooves is shown in FIG. 1(e). However, any desired number and position of the grooves could be used.

FIG. 1(f) is a cross-sectional view of another type of spacer module 76 that can be used in the present invention. Module 76 has a male end 78 that is conical in shape as well as an input end 84 that has a conical interior 80 with grooves 82 therein. Again, the grooves extend longitudinally from the input end 84 to the end 86 of the truncated cone 80. It has an interior bore 79 that has an inside diameter 88 that will be a slightly smaller diameter than the mating female module bore to allow the boundary layer to be formed as explained earlier and hereafter.

FIG. 1(g) is a cross-sectional view of a module 90. It has a male, conical shaped output end 92 and an input end 96. However, the input end 96 does not have a conical shape and the bore 93 has a constant diameter 94 therethrough that would be used to match a bore diameter of a mating module.

FIG. 1(h) and FIG. 1(i) are simply ring shaped spacer modules 60 and 62 with module 60 having a bore with an inside diameter 61 and module 62 having an inside diameter 63 respectively. FIG. 2 illustrates a cross-sectional view of an example of a two-module stacked assembly nozzle 99 that will allow a primary fluid and a secondary fluid to form an output fluid stream. The modules shown in FIG. 2 are taken from the modules in FIG. 1 and will be numbered accordingly. The nozzle assembly 99 is formed with an outer housing 98 encasing output module 10 (shown in FIG. 1(a)), spacer module 90 (shown in FIG. 1(g)), and spacer module 60 (shown in FIG. 1(h)). The conical end 92 of the spacer module 90 sealingly engages the conical surface 16 of the output module 10. However, the grooves 18 in the conical surface 16 of output module 10 allow a secondary fluid to be admitted to the primary fluid. The secondary fluid is admitted through orifice 102 in outer housing 98 to a recess 104 that extends circumferentially around the inside diameter of housing 98. The secondary fluid then enters circumferentially extending space 105 where it can enter all of the grooves 18 of the output module 10. Notice that the inside diameter of the spacer module 90 is slightly smaller than the inside diameter of the output module 10. This difference in diameter is exaggerated in FIG. 2 for purposes of explanation. However, in actuality the difference is only in the thousandths of an inch (for example only, 0.002 inch). When the secondary fluid is at a low pressure or volume, it enters the primary fluid bore on the outside of the primary fluid in the circumferential space designated by the phantom lines 112 in FIG. 2. This space forms the boundary layer for the secondary fluid that encircles and encases the primary fluid. The primary fluid is slightly constricted and its velocity is increased. Also, if the secondary fluid is air, the boundary layer decreases the surface tension of the primary fluid and also increases its velocity. This is not the case with the prior art.

Further, the difference in diameter allows the low pressure, low volume, secondary fluid to enter the primary stream substantially parallel to the flow of the primary fluid. Thus, the secondary fluid is not sheared by the primary fluid as is the case with the prior art. The output of the nozzle barrel 12 is a fluid stream that is primarily a concentrated stream that is formed with large fluid droplets.

Such a powerful stream could be used with aircraft that carry a liquid fire fighting fluid to be dispelled over a fire. By placing the nozzle such that its output is parallel to the fire fighting fluid discharge where it is dropped openly or by placing one or more nozzles within a firefighting fluid container, the secondary fluid causes the firefighting fluid to be increased in velocity as it exits the container and thus tends to carry the fire fighting fluid in a continuous, substantially liquid stream as it exits the aircraft.

If the secondary fluid volume (or pressure is increased), the volume of the primary fluid is increased but the secondary fluid penetrates more to the center of the primary fluid as illustrated by arrows 110. This causes a greater agitation of the primary fluid while increasing its velocity. Thus, the output of the nozzle barrel 12 is a fluid stream that is primarily vapor formed of small fluid droplets.

To ensure that the secondary fluid input orifice 102 in housing 98 is in the proper location to admit the secondary fluid to circumferentially extending recess 104 and space 105, a spacer 60 (FIG. 1(h)) is placed between input end 96 of spacer module 90 and the insert 100.

The entire assembly 99 is held together in proper relationship with a forward plate 109 that has at least one threaded orifice 110 for receiving a bolt to tighten plate 109 to the body assembly 99. At the rear of the assembly is an insert 100 that is designed to receive a standard connection such as from a hose or other input source. It also has orifices 114 at least one of which has threads for receiving a bolt to hold the insert 100 tightly in place.

The outlet shown in FIG. 2 can be operably coupled to a hose or pipe to perform some functions such as providing power to another similar device acting as a secondary fluid source or extending the output to a flexible hose to perform some task in firefighting, cleaning, or powering a tool and the like. In another application a tool or device can be attached at the flange end at fastening points 114. In still another application, it can be used for providing a propulsion means for a water craft. Because the nozzle creates considerable noise during operation, the use of the nozzle in an underwater craft not only propels it but also generates sufficient noise to enable the underwater craft to be used as a decoy to lure sound following devices away from primary targets.

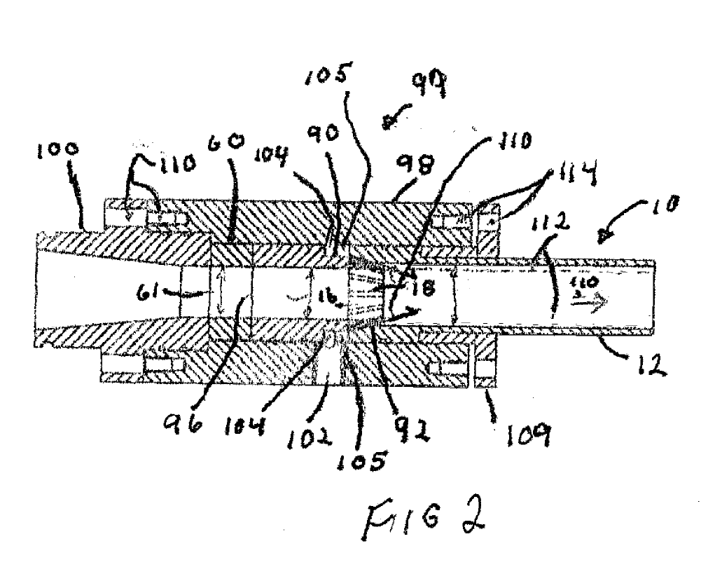

FIG. 3 is exactly like FIG. 2 except that ring spacer 60 has been removed and spacer module 48 (from FIG. 1(d)) is placed between output module 10 and spacer module 90. This arrangement forms a three-module nozzle assembly 116. In this assembly 116, the secondary fluid can enter through port 102 of the housing 98, pass through the circumferential recess 104, enter the grooves 18 of the output module 10, and exit into the primary fluid stream traveling in the direction of arrow 108. This is exactly the operation described in relation to the two-module nozzle assembly shown in FIG. 2. In this assembly 116, however, the secondary fluid entering the housing through the port 102 can also travel through the recesses 64 formed in the periphery of the input end of spacer module 48 (Shown in FIG. 1(d)) into the vacant area 118, through the grooves 54 in the truncated cone on the inside of input end 56, and into the primary fluid stream flowing in the direction of arrow 108.

It will be noted that inside diameter 97 of module 90 is slightly smaller than the inside diameter 59 of module 48 which is also slightly smaller than the inside diameter 32 of output module 10. Thus, a boundary layer is formed in both the center spacer module 48 and in the output module 10. These two boundary layers act as described previously to enable the secondary fluid, which may be air, to encircle the primary fluid and reduce surface tension and to slightly constrict the primary fluid stream to increase the velocity of the primary fluid stream as it exits from nozzle 12 of assembly 10. In FIG. 3, front plate 109 and rear insert 100 are bolted to the housing 98 as explained earlier to form a unitary assembly.

It is easy to understand that the primary fluid stream may be caused to rotate by positioning the grooves 54 in module 48 to a position in between corresponding adjacent grooves 18 in module 90. Further, even better rotation will be achieved if the grooves 54 and 18 are angled downwardly in the longitudinal direction (as indicated by phantom lines 120 and 122) so that the secondary fluid actually emerges into the primary stream at an angle to the direction of flow of the primary fluid stream. Such a rotating stream can be advantageously used to reach hidden areas in material during an aircraft fire, for example. In such case, the impeller blades of a jet engine are angled so as to hide and protect the area behind them. With the use of a rotating primary fluid stream, the fluid can be caused to enter the blades at an angle and penetrate the area behind the blades.

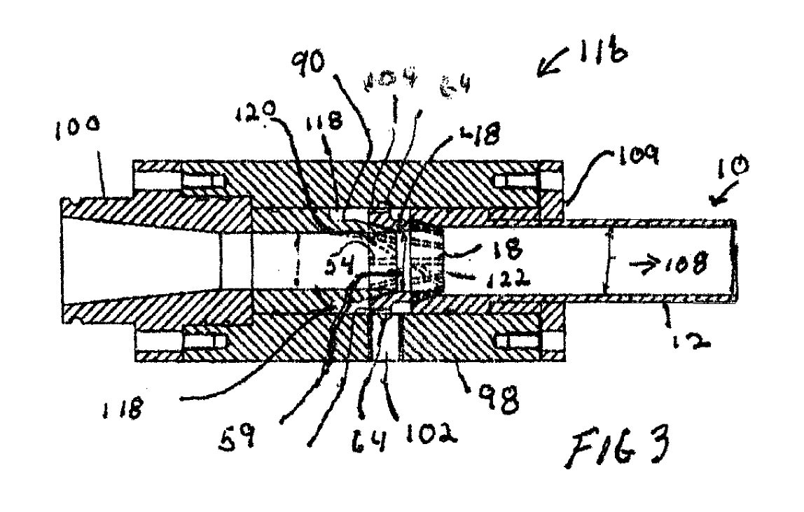

FIG. 4 is a cross-sectional representation of a four-module nozzle assembly 124. This embodiment is exactly the same as the embodiment of FIG. 3 except that an additional module 48 is placed between the modules 48 and 90 shown in FIG. 3.

Here, the orifice or input port 102 couples the secondary fluid through circumferential recess 104, recesses 64 in the two spacer modules 48, and through the respective grooves into the primary fluid stream. These embodiments are simply to show the various combinations that can be formed with the modules illustrated in FIG. 1.

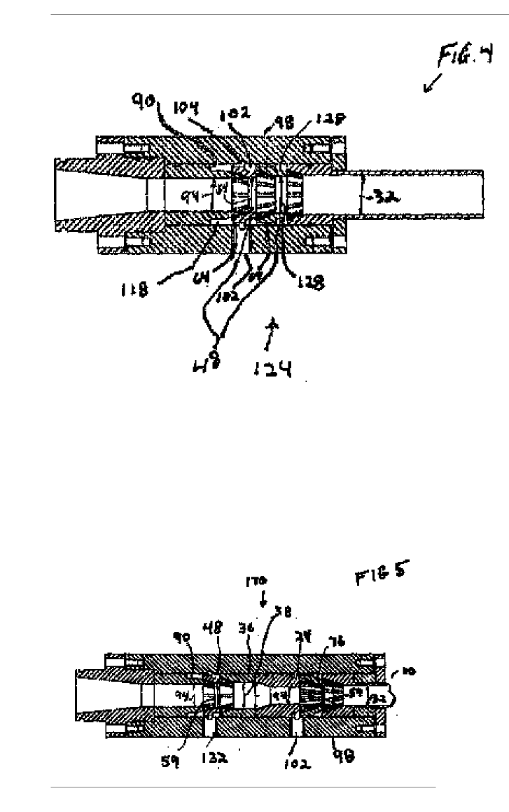

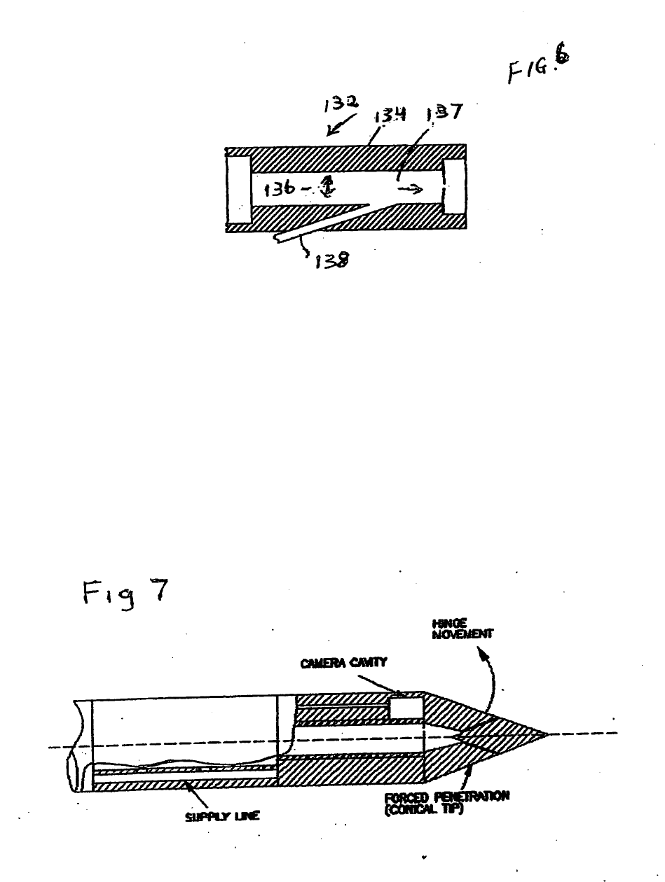

FIG. 5 is a cross-sectional view of a novel nozzle assembly 170 that has two spaced groups of the three-module assembly similar to that shown in FIG. 3. The first three-module group comprises modules 10, 76 (FIG. 1(f)), and 24. The second spaced group of three-modules comprises modules 36, 48, and 90. Again, the inside bore diameter of each preceding module in each group is slightly smaller than the inside bore diameter of the next succeeding module. There is a reduction in bore size between the inlet end diameter 34 of module 24 and the outlet bore diameter 94. Thus, diameter 94 of module 90 is slightly smaller than the diameter 59 of module 48 which is slightly smaller than the diameter 38 of module 36. Module 24 reduces the bore size from a diameter 38 to a diameter 94. Then, diameter 94 is slightly smaller than diameter 59 which is slightly smaller than diameter 32. This decrease in bore size causes an increase of velocity of the primary fluid stream through the remaining modules 76 and 10. It also serves to regulate the volume of fluid per minute flow rate.

Further, there are two secondary fluid input ports in housing 98 at 102 and 132 for the introduction of the same one or of two different secondary fluids. Each group operates as explained previously. In one embodiment, the same secondary fluid is introduced at each of the ports 102 and 132 simply to better shape and form the primary input fluid by changing the pressure/volume of the secondary fluid.

In another embodiment, the two secondary fluids are different. One may be air for shaping and forming the primary fluid flow while the other may be a particular chemical that is added for fighting a particular type of fire. Each end of the unit is sealed as described previously.

FIG. 6 is a cross-sectional view of an embodiment 132 that is a module for adding a secondary fluid in the form of solid or semi-solid objects to the primary stream. The objects may be hollow spheres of frangible material filled with a desired fluid for fire fighting, a chemical such as tear gas, or a biological agent such as microbes used to attack oil spills. The embodiment 132 has a housing 134 with an interior bore 136 for carrying the primary fluid.

A secondary fluid input orifice 138 is of a size that it can carry the spherical objects into the interior bore 136 where the primary fluid flows in the direction illustrate by the arrow 137. The spherical objects, either solid or hollow, can be inserted into orifice 138 in a manner well known in the art. Orifice 138 can be sized to be used for proportioning a mixture or for introducing a solid, or a spherical projectile as mentioned previously. The diameter of 138 will always be less than the diameter of 136. It is further noted that input orifice 138 is formed in the housing 134 at an angle that will allow the solid or hollow spherical objects to easily enter the primary fluid stream.

While not shown in the drawings, those skilled in the art will realize that such a nozzle as has been described can be used as a water vehicle propelling device. It is well known in the art that water jet devices are used to propel boats, water scooters, and the like. The water jet nozzles in those devices can be replaced with the novel nozzle disclosed herein. The primary fluid can be operably coupled to an impeller pump as the water intake from a lake, river, or other water source. The secondary fluid can be air that is produced in any well known manner such as with an air pressure device and appropriate valves.

Thus there has been disclosed a novel high velocity, high pressure, fluid nozzle that uses a primary fluid that can be controlled by a secondary fluid in a novel manner.

The fluid nozzle assembly comprises a series of concatenated modules. Each adjacent pair of modules can be constructed such that a secondary fluid can be added to a primary fluid in such a manner that the secondary fluid envelopes and encases the primary fluid in a boundary layer to both increase the velocity of the primary fluid and reduce the surface tension of the primary fluid with the inner wall of the primary fluid carrying orifice. This is accomplished by making the inside diameter of the primary fluid carrying bore of each succeeding module slightly larger than the bore of the preceding module.

By making the bore diameter increase slightly from one module to another allows the secondary fluid to enter the boundary layer substantially parallel to the primary fluid. Again, the velocity of the primary fluid increases because of the reduced surface tension and the force of the secondary fluid.

The nozzle assembly can also eject fluids, flowable solids such as solid or hollow spherical objects. The hollow objects can include fire retardants, chemicals, or biological materials to be used for various purposes.

In addition, the nozzle may be used to propel watercraft such as boats, water skis, and the like.

While particular embodiments of the invention have been shown and described in detail, it will be obvious to those skilled in the art that changes and modifications of the present invention, in its various embodiments, may be made without departing from the spirit and scope of the invention. Other elements, steps, methods, and techniques that are substantially different from those described herein are also with the scope of the invention. Thus, the scope of the invention should not be limited by the particular embodiments described herein but should be defined by the appended claims and equivalents thereof.

What is claimed is:

1. An advanced high pressure fluid nozzle apparatus comprising:
at least a first fluid carrying module having a male portion and a second fluid carrying module having a female portion and detachably connected to each other, each of the first and second modules having a fluid carrying input orifice and a fluid carrying output orifice; the male module having a conically shaped outer surface tapering inwardly from a first outer diameter to a second smaller outer diameter; the female module having a conically shaped inner surface matching at least a portion of the conically shaped outer surface of the male module for receiving the fluid output of the male module in fluid tight relationship; and at least one groove in one of the conically shaped surfaces extending longitudinally inwardly and downwardly in the direction of the fluid output for admitting a secondary fluid that travels through the at least one groove to the primary fluid carried by the female module to constrict and increase the velocity of the primary fluid.

2. The apparatus of claim 1 further comprising: a cylindrical housing having a wall and enclosing the detachably connected male and female modules in fluid tight relationship; and an orifice in the housing wall to admit the secondary fluid from an external source that travels through the at least one groove to the primary fluid in the female module to increase the velocity of the primary fluid.

3. The apparatus of claim 2 wherein: a plurality of spaced grooves are formed on the conically shaped inner portion of the female module.

4. The apparatus of claim 3 wherein the plurality of grooves are formed around the circumference of the conically shaped inner portion of the female module.

5. The apparatus of claim 3 wherein: the fluid carrying output orifice of the male module has a first diameter; and the fluid carrying input orifice of the female module has a second diameter sufficiently larger than the first diameter of the male module output orifice to provide a boundary layer area that enables the secondary fluid to encircle and constrict the primary fluid causing an increase in velocity of the primary fluid.

6. The apparatus of claim 5 further comprising: at least a third module interposed between the male and female modules and having a fluid input end with an outer surface and an inner female surface, a male surface forming the fluid output end, and a primary fluid carrying bore; a radial wall on the outer surface of the third module extending circumferentially about its fluid input end, the radial wall having an outer diameter and an inner diameter, the male surface having a conical shape on the fluid output end that tapers inwardly from the inner diameter of the radial wall to a smaller diameter to match the conical shape of the inner female surface of the female module; the inner female surface of the third module having a conical shape at matches the conically shaped outer male surface of the male module; and at least one groove in one of the conically shaped outer male surface of the male module and the inner female surface of the third module for admitting at least the secondary fluid that travels through the at least one groove to the primary fluid carried by the third module in the primary fluid carrying bore.

7. The apparatus of claim 6 further comprising: A circumferentially spaced recesses in the radial wall of the third module to allow at least the secondary fluid from the external source to travel to and pass through the at least one groove in the female surface of the third module.

8. The apparatus of claim 1 wherein the primary fluid is any liquid fluid.

9. The apparatus of claim 1 wherein the secondary fluid source is one of the group consisting of compressed air, steam or gas, a water supply pump, and a flowable solid material ejector.

10. The apparatus of claim 1 wherein the secondary fluid is air or a gas.

11. The apparatus of claim 1 wherein the secondary fluid is a flowable solid material.

12. The apparatus of claim 11 wherein the flowable solid contains a plurality of round projectiles.

13. The apparatus of claim 12 wherein: each projectile is hollow and made of frangible material; and each hollow projectile contains a material taken from the group consisting of a fire retardant material, a chemical material, and a biological agent.

14. The nozzle apparatus of claim 1 further comprising: support equipment for providing the source of the secondary fluid.

15. The apparatus of claim 14 wherein the support equipment for providing the source of the secondary fluid further comprises: one of compressed air tanks or compressor, a water supply pump, and a solid material ejector.

16. An advanced high pressure fluid nozzle apparatus comprising: a plurality of fluid carrying modules cascaded in detachable mating male/female surface relationship, the plurality of cascaded modules forming a continuous primary fluid carrying orifice; at least one groove on selected female surfaces of the cascaded fluid carrying modules; a hollow housing having a wall that surrounds and encases the cascaded fluid carrying modules in fluid tight relationship with respect to each other; and at least one orifice in the housing wall for each of the plurality of selected female surfaces having the at least one groove for enabling each of the plurality of secondary fluids to be admitted to the primary fluid through the corresponding at least one groove.

17. An advanced high pressure fluid nozzle apparatus comprising: at least first and second detachable modules; the first module having a longitudinally extending bore with a fluid input for carrying a primary stream of fluid to a fluid output; the second module being removably coupled to the first module and having a longitudinally extending bore with a fluid input portion for receiving the primary stream of fluid from the fluid output portion of the first module and ejecting the primary stream of fluid at a fluid output portion; the fluid input portion of the second module comprising a conical shaped inner portion tapering from a first diameter to a second smaller diameter; a plurality of spaced slots running inwardly and downwardly from the first diameter of the conical shaped inner portion to the second smaller diameter; the fluid output portion of the first module having at least a portion that is conically shaped with a taper that matches the taper of, and being inserted in, the fluid input portion of the second module; a housing enclosing the first and second modules in liquid tight relationship; and an orifice in the housing to admit a secondary fluid that travels through the plurality of spaced slots to the primary fluid to increase the velocity of the primary fluid.

18. A method of forming a high pressure, high velocity fluid discharge nozzle comprising the steps of: concatenating a plurality of primary fluid carrying modules, each module having a bore for carrying the primary fluid; forming at least some of adjacent concatenated modules with fluid tight connections that allow a boundary layer area to be formed about the primary fluid; and providing at least one secondary fluid carrying passage in the fluid tight connection of at least one of the adjacent modules to enable the secondary fluid to enter the boundary layer to encircle and substantially enclose the primary fluid thereby reducing surface tension of the primary fluid and increasing the velocity of the primary fluid.

19. The method of claim 18 wherein the step of forming at least some of the adjacent modules with fluid tight connections further comprises the steps of: forming one module as a female module with a female portion in the shape of a conical shaped truncated cone that extends inwardly to the primary fluid carrying bore; forming the preceding module as a male module with a male portion that mates with at least a portion of the conical shaped truncated cone input of the female module in a fluid tight relationship; and forming at least one groove in at least one of the female portion and the male portion to enable a secondary fluid to pass through the groove into the primary fluid carrying bore.

20. The method of claim 19 further comprising the steps of: maintaining the secondary fluid in a first pressure range to cause the secondary fluid to fill a boundary layer and surround the primary fluid to cause a fluid stream output that is primarily liquid; and increasing the pressure of the secondary fluid above the first pressure range to cause a fluid stream that is primarily vapor.
